(19) United States
(12) Patent Application Publication
(10) Pub. No.: US 2006/0215013 A1
(43) Pub. Date: Sep. 28, 2006

(54) Device for coupling an endoscope to a videophone

(76) Inventors: Peter Johannes Maria Jongsma, Driehuis (NL); Werner Hans Schölly, Denzlingen (DE)

Correspondence Address: Abelman Frayne & Schwab, 666 Third Avenue, New York, NY, 10017-5621, US

(21) Appl. No.: 10/568,848

(22) PCT Filed: Aug. 12, 2004
(86) PCT No.: PCT/NL04/00568

§ 371 Date: Feb. 15, 2006

(30) Foreign Application Priority Data
Aug. 15, 2003 (NL) 1024115

(51) Int. Cl. H04N 7/14

(52) U.S. Cl. 348/14.08

(57) ABSTRACT

The invention describes an adapter for coupling an optical system, such as an endoscope, to a videophone, for example a mobile telephone having a camera By coupling an endoscope to a videophone, an image can be transmitted directly to a remote observer. If the videophone has a screen, the image can also be viewed by the user on the screen without having to make use of an image processing system with a conventional screen. The adapter makes possible a simple and inexpensive method for viewing and transmitting an image of a part of an object.

The invention relates to a device for coupling an optical system to an image processing system.

Both in the medical field and in industry, use is made of endoscopes or microscopes to be able to perform inspections on internal or external parts of people or animals, but also of technical objects like machines and vehicles. Increasingly the images produced with optical systems are recorded using a camera, see for example patent publication U.S. Pat. No. 4,722,000. There is also the possibility of constructing the endoscope or microscope as a videoscope. In that case an electronic image sensor, such as a CCD or C-mos chip is incorporated in the microscope or in the tip of the endoscope. A recorded electronic image can then electronically be processed. For example, the quality of the image can be adjusted, or the image can be stored or transmitted.

Patent publication U.S. Pat. No. 6,532,298 describes an iris imager electronically connected to a telephone. An image captured by the iris imager is sent to a receiver in a vehicle or other asset and compared to a database of previously stored images to identify a person. The imager is part of a security module to protect access to an asset such as a vehicle or residence.

In patent publication U.S. Pat. No. 6,106,457 an imaging instrument is described including a compact hand-held housing having an electronic imaging element supported in a housing, and a plurality of interchangeable instrument heads separably attachable to the housing. The instrument heads include an optical system disposed in alignment with the electronic imaging element along an instrument viewing axis. The imaging instrument is connected to a computer using a receiving cradle in order to transfer recorded data to the computer.

For specific purposes, a high level of flexibility is needed when using an optical system. Optical systems may be operated in places without access to mains or without access to a computer network. Known systems for transferring recorded images in electronic format in those conditions are often expensive or impractical.

The aim of the present invention is to provide a simple way for investigating an image of a part of an object, recorded by an optical system, remote from the object to be investigated. This aim is achieved with a device for coupling an optical system to an image processing system, characterised in that the image processing system comprises a videophone and in that the device is equipped such that an image to be generated by the optical system can be recorded by a camera of the videophone. The term optical system is used for any system arranged to view a part of an object or person with the human eye, comprising at least a lens.

The optical system may comprise an endoscope or a microscope or any other optical system used for investigating a part of an object or person. An endoscope may be either flexible or rigid. Preferably, the videophone is a mobile telephone. Current mobile telephones are very convenient and can be coupled for example to an endoscope surprisingly easily. Mobile telephones with integrated cameras are very compact and the quality thereof is suitable for being able to observe endoscope images well. Telephones with small screens are now available and photographs can be transmitted easily as digital images. By coupling the camera of a mobile telephone to an endoscope or a microscope probe, the image observed can be viewed directly on the screen of the telephone and then directly stored and/or sent to any desired address in digital format.

The invention can be employed with mobile telephones which have a camera integrated in the telephone housing, but is not restricted to this variant. The optical system can also be coupled to a separate camera connected to the mobile telephone.

Because the image that is generated by the optical system can be recorded by the mobile telephone, this image can then be viewed directly via the mobile telephone, but can also be transmitted directly via SMS (MMS) or e-mail. Mobile telephones are being continually further developed, such as, for example, I-mode phones, Bluetooth, UMTS, etc. The invention makes it possible always to work with the most up-to-date mobile telephones, possibly by modifying the adapter.

The invention also relates to a system comprising an optical system, a videophone and an adapter arranged to couple said optical system to said videophone in such a way that an image to be generated by the optical system can be observed and recorded by a camera of said videophone.

The invention furthermore relates to a method for providing, remote from an object, an image of a part of the object, comprising:
coupling an optical system to a videophone provided with a camera;
recording an image of the part using the optical system and the videophone, and
transmitting the recorded image using the videophone.

The image can optionally be observed in detail, for example using a zoom adapter.

By coupling an endoscope to a videophone, it is possible to transmit an image of an abnormality or calamity in an object or person that is not discernible directly with the naked eye directly to, for example, a specialist in a remote location. The wording ‘remote from’ denotes a distance that is greater than the distance that is determined by the dimensions of the optical system. By this means, it is possible to make a remote diagnosis or to engage in medical science. Furthermore, it is pointed out that the sequence of the abovementioned steps can vary. It is also possible first to introduce, i.e. to position, the endoscope, after which the telephone is coupled, because the coupling of telephone and endoscope can be made either directly or via an eyepiece.

Further advantages and characteristics of the present invention will be clear on the basis of the description of a few illustrative embodiments by way of example, reference being made to the appended drawings, in which:

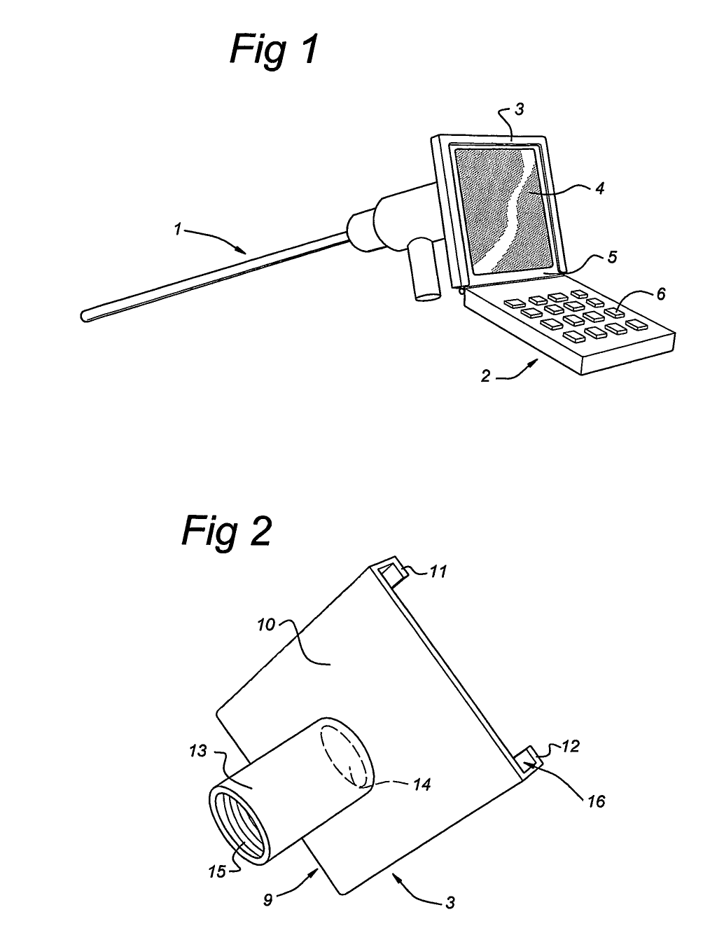

FIG. 1 shows a perspective view of an endoscope coupled to a mobile telephone;

FIG. 2 shows a perspective view of an adapter according to the invention;

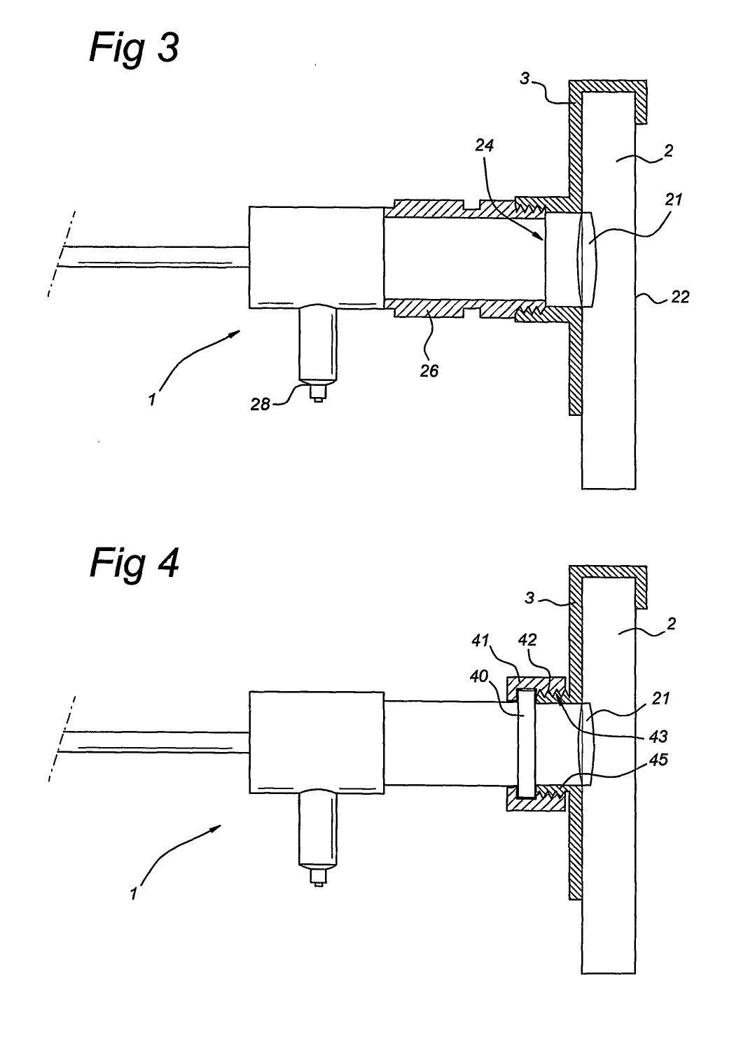

FIG. 3 shows a partial cross-section of a system of an adapter, an endoscope and a mobile telephone;

FIG. 4 shows a variant of the construction shown in FIG. 3, and

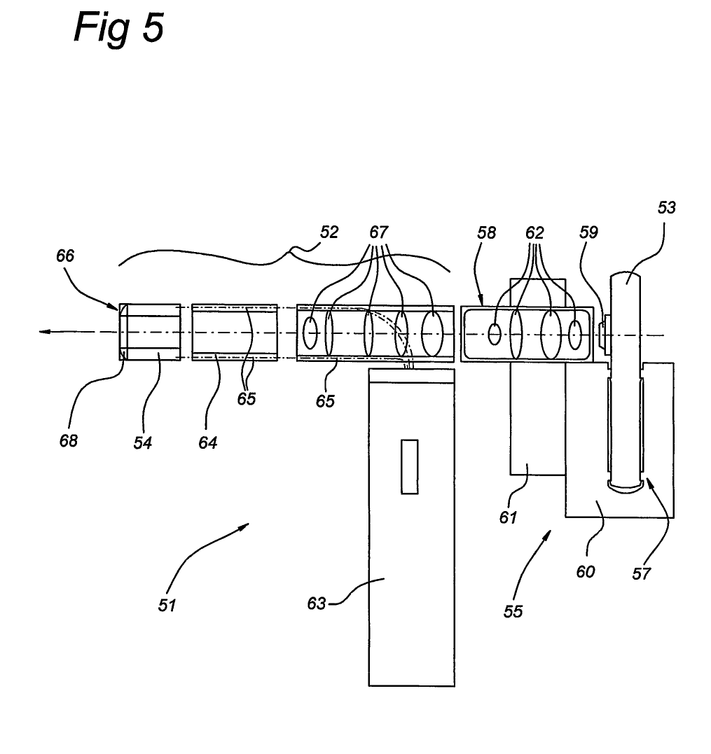

FIG. 5 shows a cross-section of a system according to an embodiment of the invention.

FIG. 1 shows one embodiment of the present invention. An endoscope 1 is coupled to a mobile telephone 2 by means of an adapter 3 according to the invention. The adapter 3 comprises a fixing element such as a slot for sliding in and accurately positioning the mobile telephone and the camera thereof. The mobile telephone 2 has a screen 4 that is contained within a flap 5. The flap 5 can hinge with respect to a keyboard part 6. In this embodiment, the adapter 3 comprises the flap 5 of the mobile telephone 2.

The adapter 3 according to FIG. 1 is shown in more detail in FIG. 2. The adapter 3 has a main panel 10 with two T-sections 11, 12 on two opposing edges of the main panel 10. Here the top 9 of the adapter 3 is a flat panel. A tubular sleeve 13 is mounted on the main panel. The sleeve 13 is mounted on the main panel 10 such that it is in front of an opening 14 in the main panel 10. This opening and the sleeve must be positioned very accurately with respect to a camera of the videophone. The sleeve 15 has screw thread on the inside for coupling an endoscope. The adapter 3 has slots 16 into which, for example, a flap of a mobile telephone can be inserted.

A partial cross-section of a system of an adapter 3, a mobile telephone 2 and a (part of an) endoscope 1 can be seen in FIG. 3. In this embodiment, a camera having a camera objective 21 is integrated in a housing 22 of the mobile telephone 2. In FIG. 3 an endoscope is shown that has an eyepiece 26 that can be focused, and a light inlet 28. The eyepiece contains a lens system and is intended for (computed) focusing of the image on the lens of a user's eye. If the endoscope with eyepiece is coupled to a mobile telephone, a user can turn the eyepiece and thus observe, focus the image that the camera of the mobile telephone registers.

The adapter 3 is optically and mechanically arranged so that an image end 24 of the endoscope (or of the eyepiece 26) is positioned in front of the camera objective 21 when the telephone 2 is coupled to the endoscope 1 via the adapter 3. If the mobile telephone has an external camera, the adapter 3 is then so equipped that this can hold the external camera instead of the housing 22 of the mobile telephone 2. If the camera objective 21 protrudes from the housing 22 of the mobile telephone 2, the camera objective 21 will be inserted in the opening 14 in the main panel 10, see also FIG. 2. The adapter 3 can, for example, be made of elastically flexible plastic, so that in the situation described above the adapter 3 can be snapped accurately into position on the mobile telephone 2, the protruding camera objective 21 acting as a sort of lock.

In one embodiment, the endoscope 1 can be attached to the videophone with the aid of the adapter 3 such that it can turn. An example of this variant is shown in FIG. 4. FIG. 4 shows a cross-section of an adapter 3 with a round attachment ring 41. The attachment ring 41 has screw thread 42 on the inside that engages on screw thread 43 on a protruding part of the adapter 3. By screwing on the attachment ring 41, the endoscope 1 is attached to the adapter 3 such that it can be turned and has no play. If a videophone is inserted into the adapter 3, a rotary coupling of the endoscope 1 to the videophone is produced; not shown. This rotary coupling is advantageous because the endoscope or the videophone can be turned such that the image observed and recorded is displayed in the desired correct manner on the screen of the videophone. As a result of this mutual rotation, an image that is always the right way up for the observer can be obtained.

In another embodiment the device (that is to say the adapter 3) has at least one lens for focusing the endoscope image on the camera objective of the mobile telephone. As a result it is possible to focus any images that are not sharp on the camera of the mobile telephone. With this embodiment it is also possible to use an endoscope without eyepiece (direct coupling). All requisite focusing means are then in the adapter. This embodiment is important if the user frequently works via the monitor of the videophone.

In a further embodiment, the adapter has at least one spacer ring for determining the distance between the image end of the endoscope and the camera objective of the videophone, such that the image to be generated by the endoscope is focused on the optoelectronic sensor of the camera. By making use of a spacer ring, the optimum distance from the endoscope and the videophone can be determined for a particular model of videophone, without the user having to focus the image. This spacer ring can have various forms. In FIG. 4 a ring 45 is shown that is fixed to the adapter 3. Attachment ring 41 can also be so sized that this serves as spacer ring.

The adapter can also be constructed as a zoom adapter; by this means the enlargement shown by the endoscope can be adjusted in steps or continuously depending on the user's requirements. In the case of rigid endoscopes the sharpness of the image is not reduced by this because the angle of view at the objective of the endoscope can be changed. In the case of flexible endoscopes, where the image conductor is made up of multiple single image conductors, the sharpness of the image is dependent on the enlargement or reduction set via the zoom adapter.

Furthermore, filters can be incorporated that make it possible to shift an image registered for an object illuminated with UV light (ultraviolet/fluorescence) into the visible wavelength range in such a way that the image can be recorded and processed in the manner described above.

In FIG. 5, a system 51 according to an embodiment of the invention is shown. The system 51 comprises an endoscope 52, a mobile phone 53 and an adapter 55. The adapter 55 is arranged to couple the endoscope 52 to the mobile phone 53 in such a way that an image to be generated by the endoscope 52 can be observed and recorded by a camera 59 of the mobile phone 53. The adapter 55 comprises a holder 60 arranged for holding the mobile phone 53. The holder 60 comprises a connection means 57 for rigidly holding the mobile phone 53 into the holder 60. Furthermore, the adapter 55 comprises a holder plate 61 connected to the holder 60 and arranged to position an optical adapter 58 with respect to the camera 59 of the mobile phone 53. The optical adapter 58 may comprise a plurality of lenses 62 arranged to optically couple the endoscope 52 with the camera 59. Here, the endoscope 52 comprises an objective 54, a spacer ring 64 and a plurality of lenses 67. The objective 54 may itself have another spacer ring 68 making it possible to place the endoscope directly onto an object to be investigated. It this way extreme close-ups are possible. In an embodiment, the spacer ring 68 is sealed by a transparent plate. The transparent plate is arranged with a line or grid structure and a scale division. This enables a correct and precise measurement of distances on the object to be investigated. The endoscope 52 also comprises optical fibers 65 arranged around the objective 54. The fibers 65 provide light to the area to be investigated. The ends of the fibers 65 may be arranged as dots around the outer end of the objective 54 or as a circle around the outer end of the objective 54.

The system 51 may also comprise a handle 63 for holding the system 51 by hand. In the handle 63, an power source, not shown, for powering an illumination system 66, may be arranged as well as a light source, not shown, for feeding light via the fibers 65, into the illumination system 66.

According to a particular embodiment, the system, consisting of endoscope-adapter, and the like, is constructed such that it can be safely used in potentially explosive atmospheres. Preferably, components of the system comply with the requirements laid down by medical authorities. More particularly, it is possible to make only the part that is used in a medical environment such that it can be sterilised/autoclaved. The other components of the system do not have to meet this requirement.

Preferably, the adapter 55 is arranged to removably couple the endoscope 52 to the mobile phone 53. In an embodiment, the connection means 57 are arranged to snap the mobile phone 53 into the holder 60.

It will be understood that variants will be immediately apparent to a person skilled in the art on reading the above. For example, it is possible to couple a non-mobile videophone instead of a mobile telephone. Moreover, the endoscope can have a flexible image conductor that can be coupled to the mobile telephone. In this variant, the end of the flexible image conductor is coupled to the telephone in a fixed manner or such that it can rotate. It is also conceivable that the housing of the videophone can easily be replaced by a housing with an integrated adapter. Such variants are considered to fall within the scope of the appended claims. Furthermore it should be appreciated that wherever the term object to be investigated is used, it can be replaced by person or animal to be investigated.

1. A system comprising an optical system (1), a videophone (2), and an adapter (3;55) arranged to couple said optical system (1) to said videophone (2) in such a way that an image to be generated by the optical system (1) can be observed and recorded by a camera of said videophone (2), said camera being integrated in a housing of said videophone, wherein the adapter (3;55) comprises a receptacle (16;60) for positioning and clamping the videophone (2).

2. The system according to claim 1, characterized in that the videophone (2) is a mobile telephone (2).

3. The system according to claim 1, characterized in that the adapter (3;55) comprises attachment means (13) for attaching the image end of the optical system (1) to the device (3;55).

4. The system according to claim 3, characterized in that the attachment means (13) are equipped such that the optical system (1) can be attached such that it can be turned relative to the videophone (2).

5. The system according to claim 1, characterized in that the adapter (3;55) comprises at least one focusing device for optically matching the optical system image to the camera of the videophone (2).

6. The system according to claim 1, characterized in that the adapter (3;55) comprises at least one first spacer ring (41) for determining the distance between the optical system (1) and the camera of the videophone (2) such that the image to be generated by the optical system (1) is displayed sharply on the camera.

7. The system according to claim 1, wherein the optical system is an endoscope (1).

8. The system according to claim 1, comprising a zoom adapter that changes image size for enlarging/reducing the image.

9. The stem system according to claim 1, comprising a filter arranged to shift the wavelength of radiation forming the image.

10. The system according to claim 1, arranged such that it can be safely used in potentially explosive atmospheres.

11. The system according to claim 1, wherein said adapter (3;55) is arrange to removably couple said optical system (1) to said videophone (2).

12. The system according to claim 1, wherein said system further comprises an interchangeable objective (54) and an illumination system (66) arranged to illuminate a range of said objective (54).

13. The system according to claim 12, wherein said system comprises a spacer ring (58) arranged onto said objective (54) so that the objective (54) can be directly placed onto an object to be imaged.

14. A method for providing, remote from an object not being a person or an animal, an image of a part of the object, comprising:
providing a videophone having a camera integrated in its housing;
coupling an optical system to said videophone by way of clamping part of said housing of said videophone into an adapter (3;55) arranged to couple said optical system to said videophone;
recording an image of the part using the optical system and the videophone, and
transmitting the recorded image using the videophone.

15. The method according to claim 14, wherein said optical system comprises an endoscope and said method comprises:
inserting an end of the endoscope intended for this purpose into the object.
